(19) United States
(12) Patent Application Publication
(10) Pub. No.: US 2025/0364848 A1
(43) Pub. Date: Nov. 27, 2025

(54) STEPPER MOTOR

(71) Applicant: AAC Microtech (Changzhou) Co., Ltd., Changzhou City (CN)

(72) Inventors: Xixi Zou, Changzhou (CN); Hongmei Yan, Changzhou (CN); Xia Zheng, Changzhou (CN)

(21) Appl. No.: 18/988,928

(22) Filed: Dec. 20, 2024

Related U.S. Application Data
(63) Continuation of application No. PCT/CN2024/095569, filed on May 27, 2024.

(51) Int. Cl. H02K 1/14; H02K 5/16; H02K 37/14

(52) U.S. Cl. CPC H02K 1/14; H02K 5/161; H02K 37/14

(57) ABSTRACT

The present application provides a stepper motor including a housing, a stator assembly, and a rotor assembly. The stator assembly is spaced around the rotor assembly. The stator assembly includes first and second driving units distributed along an axial direction of the rotor assembly. The first and second driving unit are fixed to the housing. The rotor assembly includes a rotor shaft, a first magnet and a second magnet fixedly sleeved on the rotor shaft. Two ends of the rotor shaft are rotatably connected to the housing. The first and second driving units are provided around the first magnet and the second magnet, respectively. Magnetizing directions of the first magnet and the second magnet are both perpendicular to the axial direction of the rotor shaft, which are perpendicular to each other. The stepper motor has a simple structure, is easy to assemble, and is convenient for improving the torque.

### CROSS-REFERENCE TO RELATED APPLICATIONS

This application is a continuation of International Application No. PCT/CN2024/095569, May 27, 2024, the entire contents of which are incorporated herein by reference.

### TECHNICAL FIELD

The present application relates to the field of motor technologies, in particular to a stepper motor.

### BACKGROUND

Stepper motors, due to their compact structure, high power density, high efficiency, and significant energy-saving and consumption-reducing benefits, have been widely used in fields such as motors and generators. In recent years, the industrial sector has seen a growing demand for devices that use stepper motors to directly drive loads. The widespread adoption of these stepper motor direct-drive devices is expected to yield immense energy-saving benefits.

In the related art, most traditional miniature stepper motors are permanent magnet stepper motors with claw-pole structures. In claw-pole motors, the rotor is a permanent magnet, and two stator cores axially cooperate to form claw-shaped poles, enabling motor rotation through the interaction of the stator and rotor. Besides, the claw pole is a critical component in this motor and is typically manufactured using multi-step stamping processes. However, the traditional claw-pole structures are complex, difficult to form, and suffer from poor process consistency. Additionally, the external design of most miniature stepper motors is circular, requiring special considerations during installation. Furthermore, the magnetic circuit is prone to saturation, making it challenging to improve the torque.

Therefore, it is necessary to provide a new stepper motor to solve the above technical problems.

### SUMMARY

An object of the present application is to provide a stepper motor having a simple structure, easy to assemble, and easy to increase torque.

In order to achieve the above object, the present application provides a stepper motor comprising a housing, a stator assembly fixed to the housing, and a rotor assembly supported in the housing and rotatably connected to the housing, the stator assembly being provided around the rotor assembly and spaced apart from the rotor assembly;
wherein the stator assembly comprises at least a first driving unit and a second driving unit distributed along an axial direction of the rotor assembly, wherein the first driving unit and the second driving unit are spaced apart from the rotor assembly and fixed to the housing;
the rotor assembly comprises a rotor shaft, a first magnet and a second magnet fixedly sleeved on the rotor shaft, wherein the first magnet and the second magnet are spaced along the axial direction of the rotor shaft, and two ends of the rotor shaft are rotatably connected to the housing; the first driving unit is provided around the first magnet, and the second driving unit is provided around the second magnet; a magnetizing direction of the first magnet and a magnetizing direction of the second magnet are both perpendicular to the axial direction of the rotor shaft, and the magnetizing direction of the first magnet and the magnetizing direction of the second magnet are perpendicular to each other.

In one embodiment, the first driving unit comprises a first iron core and a second iron core provided opposite to each other on opposite sides of the first magnet, a first frame and a second frame respectively fixed to the first iron core and/or the second iron core, and a first winding and a second winding respectively sleeved on the first frame and the second frame; wherein the first iron core and the second iron core are fixed to the housing; the first magnet is provided within an accommodating space jointly enclosed by the first iron core, the second iron core, the first winding, and the second winding;
the second driving unit comprises a third iron core and a fourth iron core provided opposite to each other on opposite sides of the second magnet, a third frame and a fourth frame respectively fixed to the third iron core and/or the fourth iron core, and a third winding and a fourth winding sleeved on the third frame and the fourth frame; wherein the third iron core and the fourth iron core are fixed to the housing, and the second magnet is provided within an accommodating space jointly enclosed by the third iron core, the fourth iron core, the third winding, and the fourth winding.

In one embodiment, the first driving unit further comprises a fifth frame, a sixth frame, a fifth winding, and a sixth winding; wherein the fifth frame and the sixth frame are provided on a side of the first frame close to the housing and a side of the second frame close to the housing, respectively; the fifth frame and the sixth frame are provided spaced apart from the first frame and the second frame, respectively; the fifth winding and the sixth winding are sleeved on the fifth frame and the sixth frame, respectively; and the fifth frame and the sixth frame are fixed to the first iron core and/or the second iron core, respectively;
the second driving unit further comprises a seventh frame, an eighth frame, a seventh winding, and an eighth winding; wherein the seventh frame and the eighth frame are provided on a side of the third frame close to the housing and a side of the fourth frame close to the housing, respectively; the seventh frame and the eighth frame are provided spaced apart from the third frame and the fourth frame, respectively; the seventh winding and the eighth winding are sleeved on the seventh frame and the eighth frame, respectively; and the seventh frame and the eighth frame are fixed to the third iron core and/or the fourth iron core, respectively.

In one embodiment, the first frame and the second frame are integrally structured with the first iron core and/or the second iron core, respectively; and the third frame and the fourth frame are integrally structured with the third iron core and/or the fourth iron core, respectively.

In one embodiment, the stepper motor further comprises a first spacer and a second spacer, wherein the first spacer is sleeved on the rotor shaft and fixed to an end of the first magnet away from the second magnet, and the second spacer is sleeved on the rotor shaft and fixed to an end of the second magnet away from the first magnet.

In one embodiment, the stepper motor further comprises a third spacer, wherein the third spacer is sleeved on the rotor shaft and sandwiched between the first magnet and the second magnet.

In one embodiment, the stepper motor further comprises a first magnetic spacer sleeved on the rotor assembly, wherein the first magnetic spacer is sandwiched between the first driving unit and the second driving unit.

In one embodiment, the stator assembly further comprises a third driving unit and a second magnetic spacer, wherein the third driving unit is spaced apart on a side of the first driving unit away from the second driving unit, and the second magnetic spacer is sleeved on the rotor assembly and sandwiched between the first driving unit and the third driving unit; a side of the third driving unit away from the first driving unit is fixed to the housing;
the rotor assembly further comprises a third magnet, which is fixedly sleeved on the rotor shaft and located on a side of the first magnet away from the second magnet; the third driving unit is spaced apart from the third magnet and sleeved on the third magnet, and a magnetizing direction of the third magnet is the same as the magnetizing direction of the second magnet.

In one embodiment, the housing comprises a first cover plate and a second cover plate provided opposite to each other along the axial direction of the rotor shaft; the first driving unit is fixed to the first cover plate, and the second driving unit is fixed to the second cover plate; the two ends of the rotor shaft are rotatably connected to the first cover plate and the second cover plate, respectively.

In one embodiment, the stepper motor further comprises a first bearing and a second bearing, wherein at least a portion of an outer peripheral side of the first bearing is fixed in the first cover plate, and at least a portion of an outer peripheral side of the second bearing is fixed in the second cover plate; two ends of the rotor shaft are inserted and fixed in an inner side of the first bearing and an inner side of the second bearing, respectively.

In one embodiment, the first bearing comprises a first bearing body and a first tab formed by a protrusion of a side of the first bearing body close to the first magnet;
the second bearing comprises a second bearing body and a second tab formed by a projection of a side of the second bearing body close to the second magnet;
an outer peripheral side of the first tab is fixed in the first cover plate, and an outer peripheral side of the second tab is fixed in the second cover plate; the two ends of the rotor shaft are inserted and fixed on an inner side of the first tab and an inner side of the second tab, respectively.

In one embodiment, the first iron core and the second iron core are recessed on one side opposite to each other to form a first countersunk hole and a second countersunk hole, respectively; the first countersunk hole and the second countersunk hole are spaced apart along a radial direction of the rotor shaft, and the first frame and the second frame are assembled within the first countersunk hole and the second countersunk hole, respectively;
the third iron core and the fourth iron core are recessed on one side opposite to each other to form a third countersunk hole and a fourth countersunk hole, respectively; the third countersunk hole and the fourth countersunk hole are spaced apart along the radial direction of the rotor shaft, and the third frame and the fourth frame are assembled within the third countersunk hole and the fourth countersunk hole, respectively.

In one embodiment, the first iron core, the second iron core, the third iron core, and the fourth iron core are each formed by stacking multiple layers of iron cores.

Compared with the related art, in the stepper motor of the present application, the stator assembly is provided around the rotor assembly and spaced apart from the rotor assembly by supporting the rotor assembly in the housing and rotatably connected to the housing. The stator assembly includes at least a first driving unit and a second driving unit distributed along the axial direction of the rotor assembly, and the first driving unit and the second driving unit are spaced apart from the rotor assembly. The first driving unit and the second driving unit are fixed to the housing. The rotor assembly includes a rotor shaft, a first magnet and a second magnet fixedly sleeved on the rotor shaft. The first magnet and the second magnet are spaced along the axial direction of the rotor shaft, and two ends of the rotor shaft are rotatably connected to the housing; the first driving unit is provided around the first magnet, and the second driving unit is provided around the second magnet; a magnetizing direction of the first magnet and a magnetizing direction of the second magnet are both perpendicular to the axial direction of the rotor shaft, and the magnetizing direction of the first magnet and the magnetizing direction of the second magnet are perpendicular to each other. By setting the first driving unit and the second driving unit corresponding to the first magnet and the second magnet, respectively, and setting the magnetization direction of the first magnet and the magnetization direction of the second magnet always perpendicular to each other, thereby realizing the rotation of the rotor shaft and effectively improving the motor torque. The rectangular design of the first and second driving units ensures high spatial utilization, facilitating miniaturized designs. Additionally, the simple structure enables convenient assembly of the stepper motor as a whole.

### BRIEF DESCRIPTION OF THE DRAWINGS

In order to more clearly illustrate the technical solutions in the embodiments of the present application, the accompanying drawings to be used in the description of the embodiments will be briefly introduced below. Obviously, the accompanying drawings in the following description are only some embodiments of the present application, and for the person of ordinary skill in the field, other accompanying drawings may be obtained based on these drawings without putting forth any creative labor.

FIG. 1 is a three-dimensional structural schematic diagram of a stepper motor according to Embodiment one of the present application.

FIG. 2 is an exploded view of the three-dimensional structure of the stepper motor according to Embodiment one of the present application.

FIG. 3 shows a sectional view of the stepper motor of FIG. 1 along line A-A.

FIG. 4 is a first diagram of a motion state of the stepper motor according to Embodiment one of the present application.

FIG. 5 is a second diagram of the motion state of the stepper motor according to Embodiment one of the present application.

FIG. 6 is a third diagram of the motion state of the stepper motor according to Embodiment one of the present application.

FIG. 7 is a fourth diagram of the motion state of the stepper motor according to Embodiment one of the present application.

FIG. 8 shows a structural schematic diagram of a countersunk hole according to Embodiment one of the present application.

FIG. 9 is an exploded view of the three-dimensional structure of the stepper motor according to Embodiment two of the present application.

FIG. 10 is a schematic diagram of the three-dimensional structure of the stepper motor structure according to Embodiment three of the present application.

FIG. 11 is a sectional view of the stepper motor of FIG. 10 along line B-B.

FIG. 12 shows a structural schematic diagram of the stacking of iron cores according to an embodiment the present application.

### DETAILED DESCRIPTION OF THE EMBODIMENTS

The technical solutions in the embodiments of the present application will be described clearly and completely in the following in conjunction with the accompanying drawings in the embodiments of the present application. Obviously, the described embodiments are only a part of the embodiments of the present application and not all of the embodiments. Based on the embodiments in the present application, all other embodiments obtained by a person of ordinary skill in the art without making creative labor fall within the scope of protection of the present application.

### Embodiment One

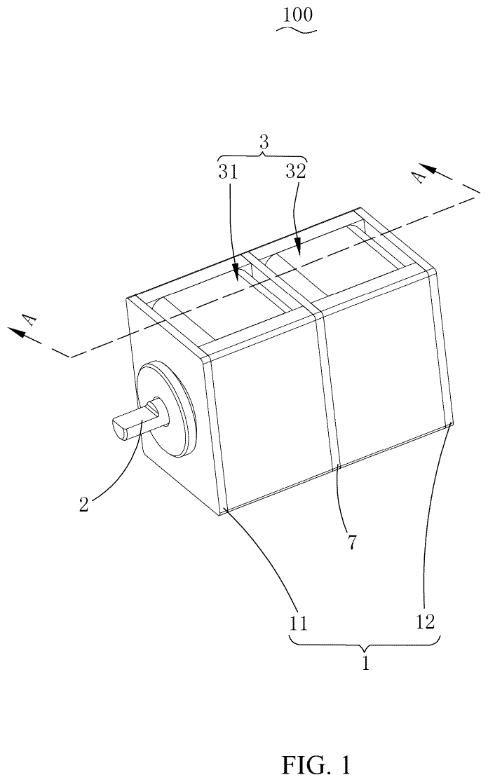

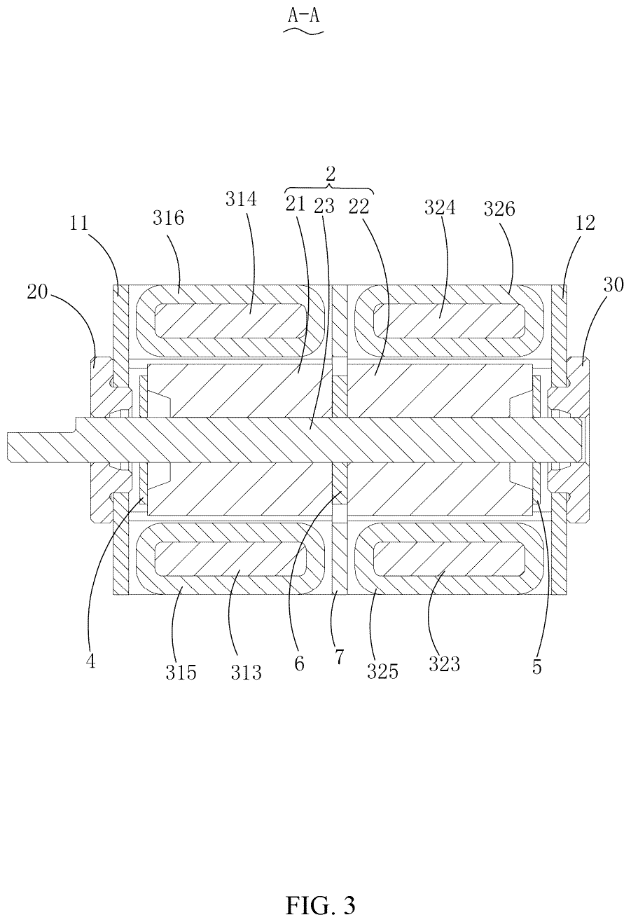

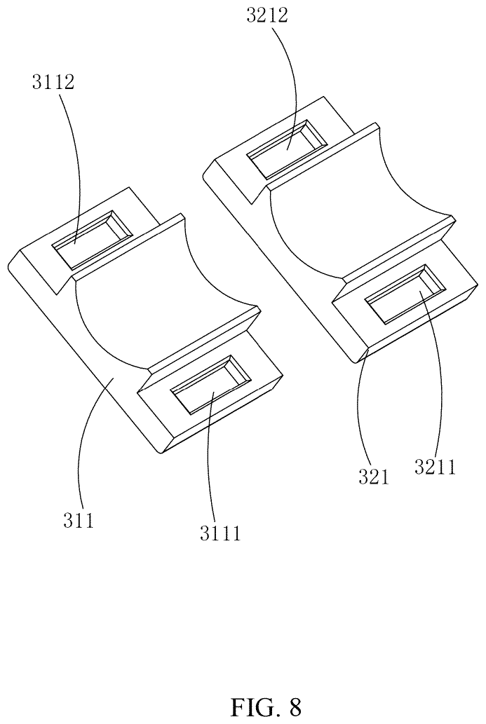

As shown in FIGS. 1 to 8, an embodiment of the present application provides a stepper motor 100 including a housing 1, a stator assembly 3 fixed in the housing 1, and a rotor assembly 2 supported in the housing 1 and rotatably connected to the housing 1. The stator assembly 3 is provided around the rotor assembly 2 and spaced apart from the rotor assembly 2. The housing 1 is configured to support and set the stator assembly 3 and the rotor assembly 2, and the stator assembly 3 interacts with the rotor assembly 2 to generate a magnetic field to drive the rotor assembly 2 to rotate on the housing 1, realizing the driving function of the stepper motor 100.

The stator assembly 3 includes at least a first driving unit 31 and a second driving unit 32 distributed along an axial direction of the rotor assembly 2. The first driving unit 31 and the second driving unit 32 are spaced apart from the rotor assembly 2, and the first driving unit 31 and the second driving unit 32 are fixed to the housing 1. In an embodiment, the first driving unit 31 and the second driving unit 32 are set in a rectangular structure, which facilitates miniaturized design through high space utilization of the rectangular shaped first driving unit 31 and second driving unit 32.

The rotor assembly 2 includes a rotor shaft 23, a first magnet 21 and a second magnet 22 fixed to the rotor shaft 23. The first magnet 21 and the second magnet 22 are spaced apart along the axial direction of the rotor shaft 23, and two ends of the rotor shaft 23 are rotatably connected to the housing 1. The first driving unit 31 is provided around the first magnet 21, and the second driving unit 32 is provided around the second magnet 22. A magnetizing direction of the first magnet 21 and a magnetizing direction of the second magnet 22 are both perpendicular to the axial direction of the rotor shaft 23, and the magnetizing direction of the first magnet 21 and the magnetizing direction of the second magnet 22 are perpendicular to each other. By setting the first driving unit 31 and the second driving unit 32 corresponding to the first magnet steel 21 and the second magnet steel 22, respectively, and setting the magnetizing direction of the first magnet steel 21 and the second magnet steel 22 always perpendicular to realize the rotation of the rotor shaft 23, effectively improving the torque of the motor. The rectangular design of the first driving unit 31 and second driving unit 32 ensures high spatial utilization, facilitating miniaturized designs. Additionally, the simple structure enables convenient assembly of the stepper motor 100 as a whole.

The first magnet 21 and the second magnet 22 are sintered neodymium iron boron magnets, and the grade may be selected as N52SH or other grades. They are fixed to the rotor shaft 23 by adhesive bonding, and the magnetization directions are radial parallel magnetization. The magnetizing directions of the first magnet 21 and the second magnet 22 are staggered by 90 degrees.

In this embodiment, the first driving unit 31 includes a first iron core 311 and a second iron core 312 provided opposite to each other on opposite sides of the first magnet 21, a first frame 313 and a second frame 314 respectively fixed to the first iron core 311 and/or the second iron core 312, and a first winding 315 and a second winding 316 respectively sleeved on the first frame 313 and the second frame 314. The first iron core 311 and the second iron core 312 are fixed to the housing 1, and the first magnet 21 is provided within an accommodating space jointly enclosed by the first iron core 311, the second iron core 312, the first winding 315, and the second winding 316. By fixedly mounting the first frame 313 and the second frame 314 between the first iron core 311 and the second iron core 312 and located on both sides of the rotor assembly 2, the first winding 315 and the second winding 316 are fixedly sleeved on the first frame 313 and the second frame 314, respectively. In the assembly process, the first winding 315 is first wound on the first frame 313, and the frame with the windings is then mounted within the first iron core 311 using tabs at both ends.

The first iron core 311 and the second iron core 312 are recessed on one side opposite to each other to form a first countersunk hole 3111 and a second countersunk hole 3112, respectively. The first countersunk hole 3111 and the second countersunk hole 3112 are spaced apart along a radial direction along the rotor shaft 23, and the first frame 313 and the second frame 314 are assembled within the first countersunk hole 3111 and the second countersunk hole 3112, respectively, thereby realizing a fixed connection. The second countersunk hole 3112 has the same structure as the first countersunk hole 3111 and is correspondingly provided on one side of the rotor assembly 2.

In an embodiment, the first frame 313 that sets the first winding 315 is attached to the first iron core 311 by welding or soldering. The second frame 314 is also connected in the same manner as the first frame 313, which is not described herein.

The second driving unit 32 includes a third iron core 321 and a fourth iron core 322 provided opposite to each other on opposite sides of the second magnet 22, a third frame 323 and a fourth frame 324 respectively fixed to the third iron core 321 and/or the fourth iron core 322, and a third winding 325 and a fourth winding 325 respectively sleeved on the third frame 323 and the fourth frame 324. The third iron core 321 and the fourth iron core 322 are fixed to the housing 1. The second magnet 22 is provided within an accommodating space jointly enclosed by the third iron core 321, the fourth iron core 322, the third winding 325, and the fourth winding 326.

By fixedly mounting the third frame 323 and the fourth frame 324 between the third iron core 321 and the fourth iron core 322 and located on both sides of the rotor assembly 2, the third winding 325 and the fourth winding 326 are fixedly sleeved on the third frame 323 and the fourth frame 324, respectively. In the assembly process, the third winding 325 is first wound on the third frame 323, and the frame with the windings is then mounted within the third iron core 321 using tabs at both ends.

The third iron core 321 and the fourth iron core 322 are recessed on one side opposite to each other to form a third countersunk hole 3211 and a fourth countersunk hole 3212, respectively. The third countersunk hole 3211 and the fourth countersunk hole 3212 are spaced apart along the radial direction of the rotor shaft 23, and the third frame 323 and the fourth frame 324 are assembled within the third countersunk hole 3211 and the fourth countersunk hole 3212, respectively, thereby realizing a fixed connection. The fourth countersunk hole 3212 has the same structure as the third countersunk hole 3211 and is correspondingly provided on one side of the rotor assembly 2.

In an embodiment, the third frame 323 that sets the third winding 325 is attached to the third iron core 321 by welding or soldering. The fourth frame 324 is also attached in the same manner as the third frame 323, which is not described herein.

In this embodiment, the first iron core 311, the second iron core 312, the third iron core 321, the fourth iron core 322, the first frame 313, the second frame 314, the third frame 324, and the fourth frame 324 are made of strongly magnetically conductive material.

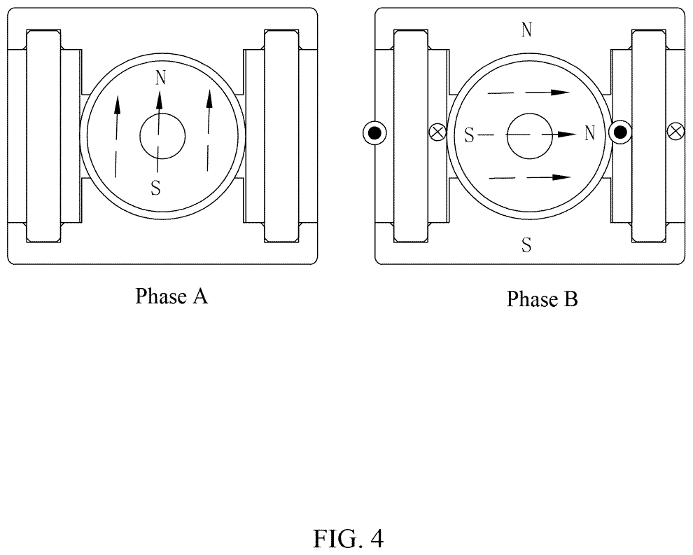

In this embodiment, the first winding 315 and the second winding 316 are defined as phase A, and the third winding 325 and the fourth winding 326 are defined as phase B. When the B phase is positively energized at the moment 0˜T/4, the windings and magnets are excited in the manner shown in FIG. 4, and the rotor magnets are subjected to a torque to rotate in the clockwise direction.

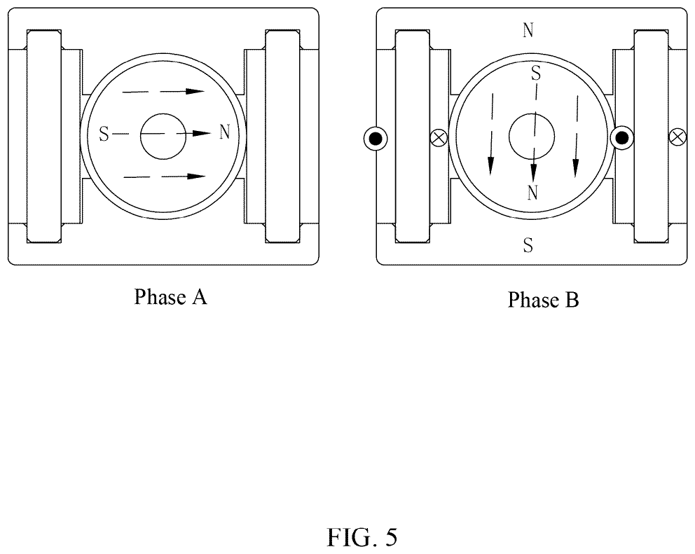

As shown in FIG. 5, the steady-state equilibrium position is reached after rotating one step angle (90 degrees).

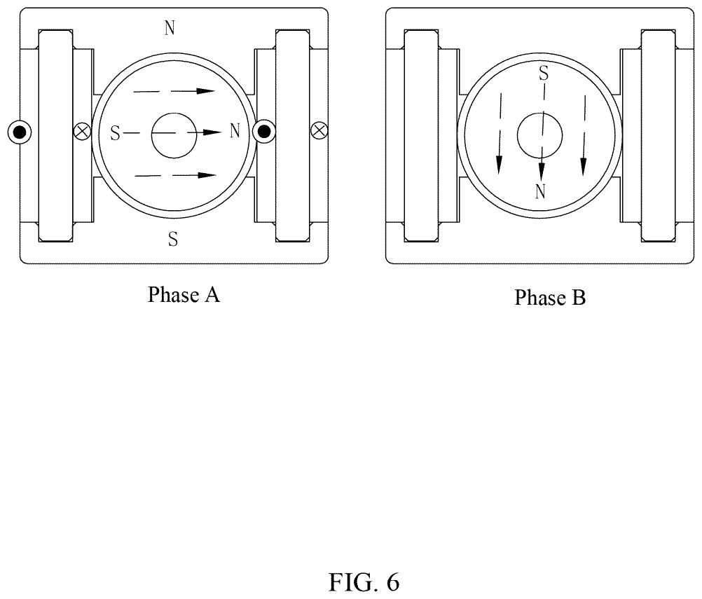

As shown in FIG. 6, when in the T/4 moment, the phase change is carried out, the phase A is energized positively and lasts for T/4 time, and the rotor magnet is subjected to the torque to rotate in the clockwise direction.

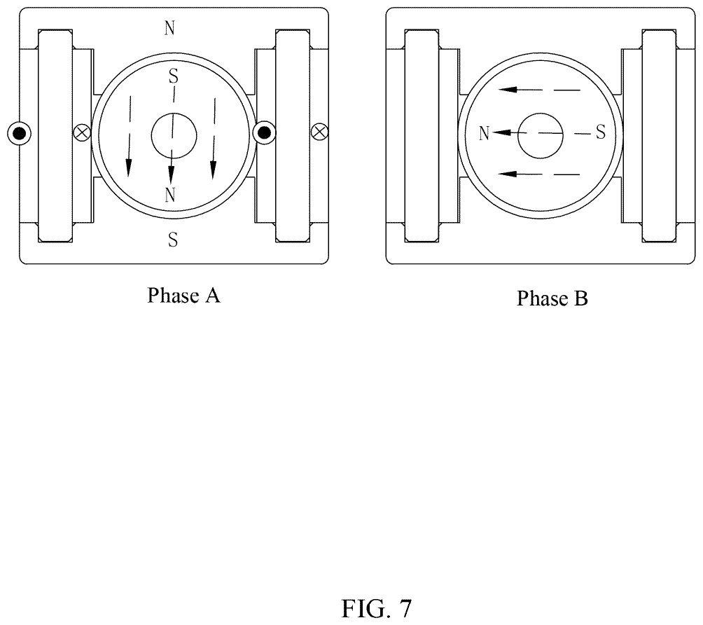

As shown in FIG. 7, after rotating one step angle (90 degrees), a new steady-state equilibrium position is reached. It is assumed that the energized signal is B+→A+→B−→A−→B+ . . . . In this way, driven by a pulse signal, the rotor rotates by one step angle and the motor achieves continuous operation in one direction.

The stepper motor 100 is a permanent magnet stepper motor 100 with a step angle of 90 degrees, and the principle of motion is shown in FIGS. 4 to 7. Counterclockwise rotation may be realized by changing the direction of energization. The energization method may be a single-phase energization or a two-phase energization. The signal may be a square-wave signal or an interpolated signal, and the rotational speed may be controlled by the signal frequency.

### Embodiment Two

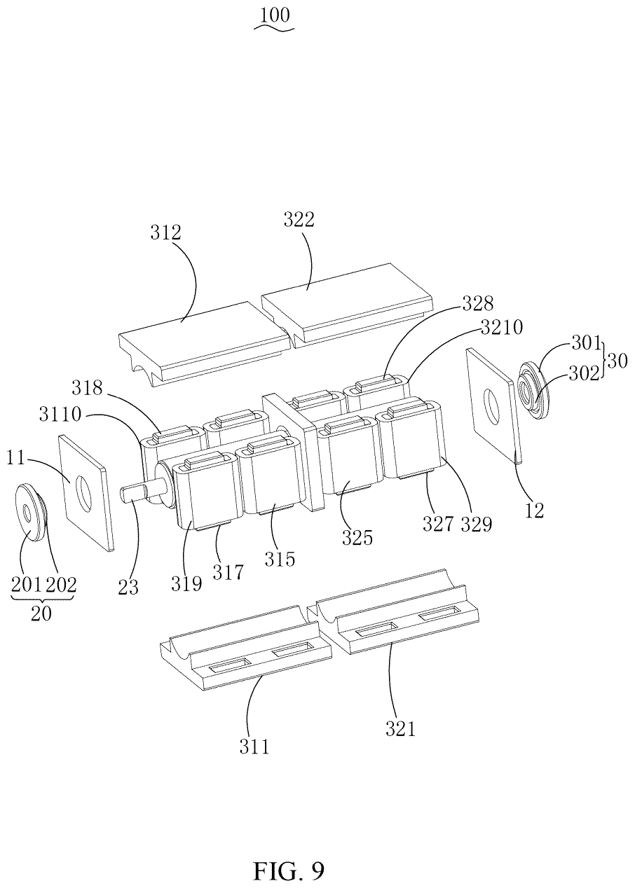

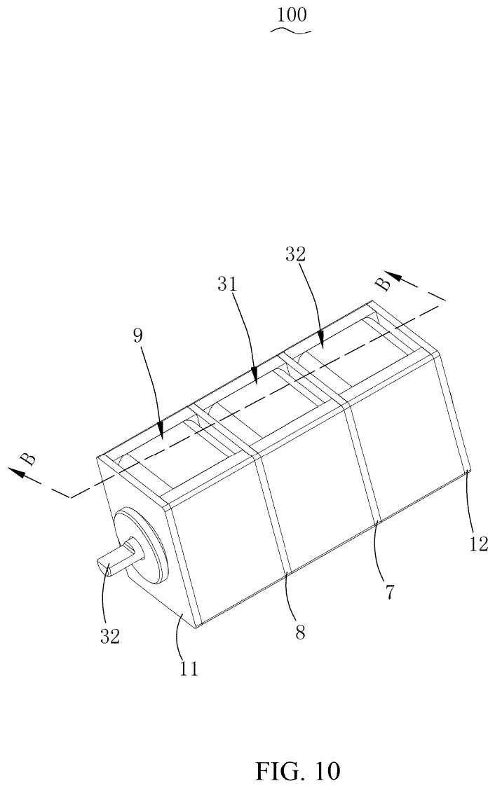

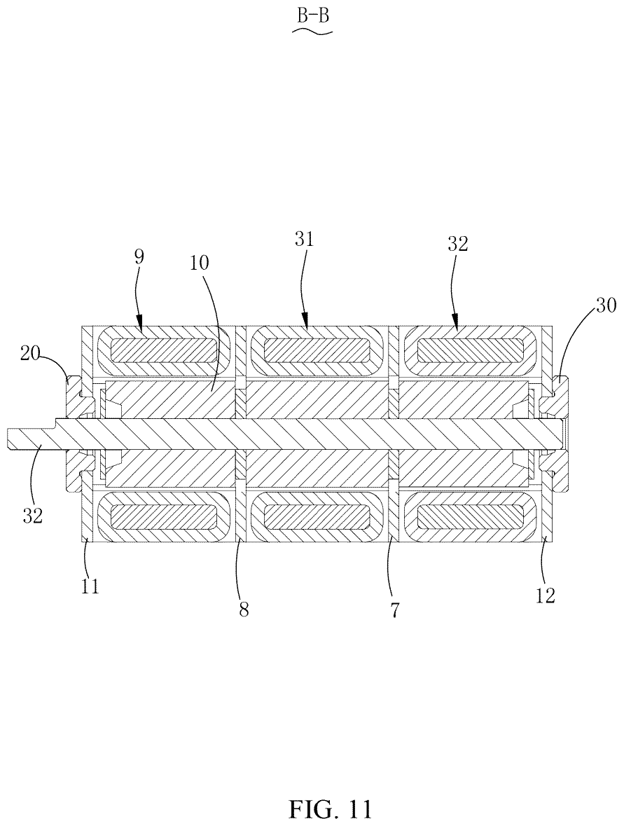

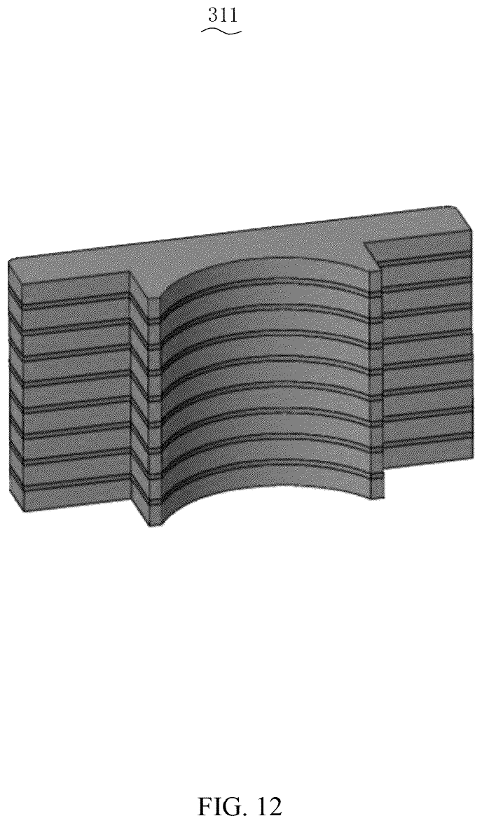

Combined with FIGS. 1 to 12, Embodiment two has the same structure as Embodiment one. On the basis of Embodiment one, in the present embodiment, the first driving unit 31 further includes a fifth frame 317, a sixth frame 318, a fifth winding 319, and a sixth winding 3110. The fifth frame 317 and the sixth frame 318 are provided on a side of the first frame 313 close to the housing and a side of the second frame 314 close to the housing, respectively. The fifth frame 317 and the sixth frame 318 are spaced apart from the first frame 313 and the second frame 314, respectively. The fifth winding 319 and the sixth winding 3110 are sleeved on the fifth frame 317 and the sixth frame 318, respectively, and the fifth frame 317 and the sixth frame 318 are fixed to the first iron core 311 and/or the second iron core 312.

The second driving unit 32 further includes a seventh frame 327, an eighth frame 328, a seventh winding 329, and an eighth winding 3210. The seventh frame 327 and the eighth frame 328 are provided on a side of the third frame 323 close to the housing 1 and a side of the fourth frame 324 close to the housing 1, respectively. The seventh frame 327 and the eighth frame 328 are spaced apart from the third frame 323 and the fourth frame 324, respectively. The seventh winding 329 and the eighth winding 3210 are sleeved on the seventh frame 327 and the eighth frame 328, respectively, and the seventh frame 327 and the eighth frame 328 are fixed to the third iron core 321 and/or the fourth iron core 322, respectively.

In an embodiment, the first driving unit 31 and the second driving unit 32 do not just include the above-described four windings per phase, but may also include multiple windings, which are not described herein.

In this embodiment, the first frame 313, the second frame 314, the fifth frame 317 and the sixth frame 318 are integrally structured with the first iron core 311 and/or the second iron core 312, respectively. The third frame 323, the fourth frame 324, the seventh frame 327 and the eighth frame 328 are integrally structured with the third iron core 321 and/or the fourth iron core 322.

In an embodiment, the first iron core 311 or the second iron core 312 may also have its own long arm structure (e.g., the first frame 313). Firstly, the coil is wound on the long arm structure of the iron core, and the iron core with the windings is then mounted within the countersunk platform of the opposite iron core using tabs at the end faces of the long arm. In one embodiment, the iron core with windings may be attached to the opposite iron core by means of welding or bonding.

In an embodiment, the long arm structures that can be wound are all centered on one side of the iron core, and the other iron core includes a countersink platform where the long arm structures can be mounted.

In an embodiment, the coils are first wound on the long arm structures of the iron core, and the iron core with the windings is then mounted within the countersink platform of the opposite iron core using tabs on the end faces of the long arms.

In one embodiment, the iron core with windings may be attached to the opposite iron core by welding or bonding, for example.

In an embodiment, the first iron core 311, the second iron core 312, the third iron core 321 and the fourth iron core 322 are each formed by stacking multiple layers of iron cores, thereby reducing the turbine loss.

In this embodiment, the stepper motor 100 further includes a first spacer 4 and a second spacer 5. The first spacer 4 is sleeved on the rotor shaft 23 and fixed to an end of the first magnet 21 away from the second magnet 22, and the second spacer 5 is sleeved on the rotor shaft 23 and fixed to an end of the second magnet 22 away from the first magnet 21. The installation of the first spacer 4 and the second spacer 5 is used to cushion the impact generated by the axial movement and improve the rotational performance of the rotor shaft 23.

In this embodiment, the stepper motor 100 further includes a third spacer 6, which is sleeved on the rotor shaft 23 and sandwiched between the first magnet 21 and the second magnet 22. The third spacer 6 is a plastic spacer, and the third spacer 6 is fixed between the first magnet 21 and the second magnet 22 by means of adhesive bonding, thereby providing a magnetic isolation effect.

In this embodiment, the stepper motor 100 further includes a first magnetic spacer 7 sleeved on the rotor assembly 2, which is sandwiched between the first driving unit 31 and the second driving unit 32. The first magnetic spacer 7 is made of a non-magnetic conductive material, effectively magnetizing the first driving unit 31 and the second driving unit 32, and improving the performance of the stepper motor 100.

### Embodiment Three

Combined with FIGS. 1 to 12, Embodiment three has the same structure as Embodiment one. On the basis of Embodiment one, the stator assembly 3 further includes a third driving unit 9 and a second magnetic spacer 8. The third driving unit 9 is spaced apart on a side of the first driving unit 31 away from the second driving unit 32, and the second magnetic spacer 8 is spaced apart and sleeved on the rotor assembly 2. The second spacer 8 is sandwiched between the first driving unit 31 and the third driving unit 9. A side of the third driving unit 9 away from the first driving unit 31 is fixed to the housing 1.

The rotor assembly 2 further includes a third magnet 10, which is fixedly sleeved on the rotor shaft 23 and located on a side of the first magnet 21 away from the second magnet 22. The third driving unit 9 is spaced apart from the third magnet 10 and sleeved on the third magnet 10. A magnetizing direction of the third magnet 9 is the same as the magnetizing direction of the second magnet 22. A three-phase motor is formed by the first driving unit 31, the second driving unit 32, and the third driving unit 9 corresponding to the first magnet steel 21, the second magnet steel 22, and the third magnet steel 10, respectively. The third driving unit 9 has the same structure as the first driving unit 31 and the second driving unit 32, and it produces the same effect.

In an embodiment, the stepper motor 100 further includes a fourth magnet unit and a fourth magnet, etc., so as to form a four-phase motor. By the same principle, the stepper motor 100 may also be a five-phase motor, a six-phase motor, etc., which will not be described herein.

In this embodiment, the housing 1 includes an oppositely provided first cover plate 11 and a second cover plate 12. The first driving unit 31 is fixed to the first cover plate 11 and the second driving unit 32 is fixed to the second cover plate 12. Two ends of the rotor shaft 23 are rotatably connected to the first cover plate 11 and the second cover plate 12, respectively.

In an embodiment, a side of the first driving unit 31 away from the second driving unit 32 is fixed to the third driving unit 9, and a side of the third driving unit 9 away from the first driving unit 31 is fixed to the first cover plate 11.

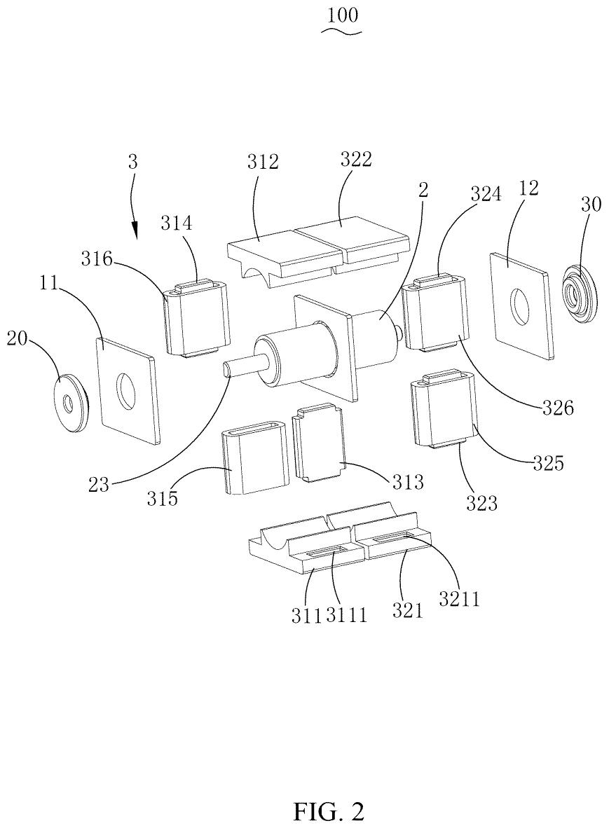

In the embodiment 1-3, the stepper motor 100 as described in FIGS. 2-3 and 9-11 further includes a first bearing 20 and a second bearing 30. At least a portion of an outer peripheral side of the first bearing 20 is fixed in the first cover plate 11, and at least a portion of an outer peripheral side of the second bearing 30 is fixed in the second cover plate 12. The two ends of the rotor shaft 23 are inserted and fixed to an inner side of the first bearing 20 and an inner side of the second bearing 30, respectively.

The first bearing 20 and the second bearing 30 are fixed to the first cover plate 11 and the second cover plate 12 by welding or riveting, respectively. The first cover plate 11 with the first bearing 20 and the second cover plate 12 with the second bearing 30 are fixed to one side of the first iron core 311 and one side of the third iron core 321, respectively, thereby realizing the overall assembly.

Specifically, the first bearing 20 includes a first bearing body 201 and a first tab 202 formed by a protrusion of a side of the first bearing body 201 close to the first magnet. The second bearing 30 includes a second bearing body 301 and a second tab 302 formed by a protrusion of a side of the second bearing body 301 close to the second magnet. An outer peripheral side of the first tab 202 is fixed in the first cover plate 11, and an outer peripheral side of the second tab 302 is fixed in the second cover plate 12. The two ends of the rotor shaft 23 are inserted and fixed on an inner side of the first tab 202 and an inner side of the second tab 302, respectively. For example, countersunk holes or through holes may be arranged through the first bearing 20 and the second bearing 30, so that the two ends of the rotor shaft 23 are respectively inserted and fixed to the first bearing 20 and the second bearing 30, respectively.

Compared with the related art, in the stepper motor of the present application, the stator assembly is provided around the rotor assembly and spaced apart from the rotor assembly by supporting the rotor assembly in the housing and rotatably connected to the housing. The stator assembly includes at least a first driving unit and a second driving unit distributed along the axial direction of the rotor assembly, and the first driving unit and the second driving unit are spaced apart from the rotor assembly. The first driving unit and the second driving unit are fixed to the housing. The rotor assembly includes a rotor shaft, a first magnet and a second magnet fixedly sleeved on the rotor shaft. The first magnet and the second magnet are spaced along the axial direction of the rotor shaft, and two ends of the rotor shaft are rotatably connected to the housing; the first driving unit is provided around the first magnet, and the second driving unit is provided around the second magnet; a magnetizing direction of the first magnet and a magnetizing direction of the second magnet are both perpendicular to the axial direction of the rotor shaft, and the magnetizing direction of the first magnet and the magnetizing direction of the second magnet are perpendicular to each other. By setting the first driving unit and the second driving unit corresponding to the first magnet and the second magnet, respectively, and setting the magnetization direction of the first magnet and the magnetization direction of the second magnet always perpendicular to each other, thereby realizing the rotation of the rotor shaft and effectively improving the motor torque. The rectangular design of the first and second driving units ensures high spatial utilization, facilitating miniaturized designs. Additionally, the simple structure enables convenient assembly of the stepper motor as a whole.

Described above are only embodiments of the present application, and it should be pointed out that, for the ordinary technical personnel in the field, improvements may also be made without departing from the premise of the concept of the present application, but these are all within the protection scope of the present application.

What is claimed is:

1. A stepper motor, comprising:
a housing;
a stator assembly fixed to the housing; and
a rotor assembly supported in the housing and rotatably connected to the housing, the stator assembly being provided around the rotor assembly and spaced apart from the rotor assembly;
wherein the stator assembly comprises at least a first driving unit and a second driving unit distributed along an axial direction of the rotor assembly, wherein the first driving unit and the second driving unit are spaced apart from the rotor assembly and fixed to the housing;
the rotor assembly comprises a rotor shaft, a first magnet and a second magnet fixedly sleeved on the rotor shaft, wherein the first magnet and the second magnet are spaced along the axial direction of the rotor shaft, and two ends of the rotor shaft are rotatably connected to the housing; the first driving unit is provided around the first magnet, and the second driving unit is provided around the second magnet; a magnetizing direction of the first magnet and a magnetizing direction of the second magnet are both perpendicular to the axial direction of the rotor shaft, and the magnetizing direction of the first magnet and the magnetizing direction of the second magnet are perpendicular to each other.

2. The stepper motor of claim 1, wherein the first driving unit comprises a first iron core and a second iron core provided opposite to each other on opposite sides of the first magnet, a first frame and a second frame respectively fixed to the first iron core and/or the second iron core, and a first winding and a second winding respectively sleeved on the first frame and the second frame; wherein the first iron core and the second iron core are fixed to the housing; the first magnet is provided within an accommodating space jointly enclosed by the first iron core, the second iron core, the first winding, and the second winding;
the second driving unit comprises a third iron core and a fourth iron core provided opposite to each other on opposite sides of the second magnet, a third frame and a fourth frame respectively fixed to the third iron core and/or the fourth iron core, and a third winding and a fourth winding sleeved on the third frame and the fourth frame; wherein the third iron core and the fourth iron core are fixed to the housing, and the second magnet is provided within an accommodating space jointly enclosed by the third iron core, the fourth iron core, the third winding, and the fourth winding.

3. The stepper motor of claim 2, wherein the first driving unit further comprises a fifth frame, a sixth frame, a fifth winding, and a sixth winding; wherein the fifth frame and the sixth frame are provided on a side of the first frame close to the housing and a side of the second frame close to the housing, respectively; the fifth frame and the sixth frame are provided spaced apart from the first frame and the second frame, respectively; the fifth winding and the sixth winding are sleeved on the fifth frame and the sixth frame, respectively; and the fifth frame and the sixth frame are fixed to the first iron core and/or the second iron core, respectively;
the second driving unit further comprises a seventh frame, an eighth frame, a seventh winding, and an eighth winding; wherein the seventh frame and the eighth frame are provided on a side of the third frame close to the housing and a side of the fourth frame close to the housing, respectively; the seventh frame and the eighth frame are provided spaced apart from the third frame and the fourth frame, respectively; the seventh winding and the eighth winding are sleeved on the seventh frame and the eighth frame, respectively; and the seventh frame and the eighth frame are fixed to the third iron core and/or the fourth iron core, respectively.

4. The stepper motor of claim 2, wherein the first frame and the second frame are integrally structured with the first iron core and/or the second iron core, respectively; and the third frame and the fourth frame are integrally structured with the third iron core and/or the fourth iron core, respectively.

5. The stepper motor of claim 2, further comprising a first spacer and a second spacer, wherein the first spacer is sleeved on the rotor shaft and fixed to an end of the first magnet away from the second magnet, and the second spacer is sleeved on the rotor shaft and fixed to an end of the second magnet away from the first magnet.

6. The stepper motor of claim 5, further comprising a third spacer, wherein the third spacer is sleeved on the rotor shaft and sandwiched between the first magnet and the second magnet.

7. The stepper motor of claim 2, further comprising a first magnetic spacer sleeved on the rotor assembly, wherein the first magnetic spacer is sandwiched between the first driving unit and the second driving unit.

8. The stepper motor of claim 7, wherein the stator assembly further comprises a third driving unit and a second magnetic spacer, wherein the third driving unit is spaced apart on a side of the first driving unit away from the second driving unit, and the second magnetic spacer is sleeved on the rotor assembly and sandwiched between the first driving unit and the third driving unit; a side of the third driving unit away from the first driving unit is fixed to the housing; the rotor assembly further comprises a third magnet, which is fixedly sleeved on the rotor shaft and located on a side of the first magnet away from the second magnet; the third driving unit is spaced apart from the third magnet and sleeved on the third magnet, and a magnetizing direction of the third magnet is the same as the magnetizing direction of the second magnet.

9. The stepper motor of claim 1, wherein the housing comprises a first cover plate and a second cover plate provided opposite to each other along the axial direction of the rotor shaft; the first driving unit is fixed to the first cover plate, and the second driving unit is fixed to the second cover plate; the two ends of the rotor shaft are rotatably connected to the first cover plate and the second cover plate, respectively.

10. The stepper motor of claim 9, further comprising a first bearing and a second bearing, wherein at least a portion of an outer peripheral side of the first bearing is fixed in the first cover plate, and at least a portion of an outer peripheral side of the second bearing is fixed in the second cover plate; two ends of the rotor shaft are inserted and fixed in an inner side of the first bearing and an inner side of the second bearing, respectively.

11. The stepper motor of claim 10, wherein the first bearing comprises a first bearing body and a first tab formed by a protrusion of a side of the first bearing body close to the first magnet;
the second bearing comprises a second bearing body and a second tab formed by a projection of a side of the second bearing body close to the second magnet;
an outer peripheral side of the first tab is fixed in the first cover plate, and an outer peripheral side of the second tab is fixed in the second cover plate; the two ends of the rotor shaft are inserted and fixed on an inner side of the first tab and an inner side of the second tab, respectively.

12. The stepper motor of claim 2, wherein the first iron core and the second iron core are recessed on one side opposite to each other to form a first countersunk hole and a second countersunk hole, respectively; the first countersunk hole and the second countersunk hole are spaced apart along a radial direction of the rotor shaft, and the first frame and the second frame are assembled within the first countersunk hole and the second countersunk hole, respectively;
the third iron core and the fourth iron core are recessed on one side opposite to each other to form a third countersunk hole and a fourth countersunk hole, respectively; the third countersunk hole and the fourth countersunk hole are spaced apart along the radial direction of the rotor shaft, and the third frame and the fourth frame are assembled within the third countersunk hole and the fourth countersunk hole, respectively.

13. The stepper motor of claim 2, wherein the first iron core, the second iron core, the third iron core, and the fourth iron core are each formed by stacking multiple layers of iron cores.
